(19) United States
(12) Patent Application Publication
(10) Pub. No.: US 2005/0198186 A1
(43) Pub. Date: Sep. 8, 2005

(54) Method for automatic discovering of logical units and storage devices connected to a virtualization switch

(76) Inventor: Mor Griv, Tel-Aviv (IL)

Correspondence Address: KATTEN MUCHIN ROSENMAN LLP, 575 MADISON AVENUE, NEW YORK, NY, 10022-2585, US

(21) Appl. No.: 10/760,890

(22) Filed: Jan. 20, 2004

(51) Int. Cl. G06F 15/167; G06F 9/00

(52) U.S. Cl. 709/212; 715/734

(57) ABSTRACT

A method and apparatus for automatic discovery of logical units (LUs) and storage devices connected to a device in a storage network, the LUs being discovered with their associated LU paths. The method and apparatus performs, for each target path, discovering LUs exposed on said target path; iteratively, for each discovered LU generating a list of LU paths associated with the discovered LU; retrieving at least attributes related to said discovered LU; and, correlating between identical LUs, thereby identifying LU paths directing to the same LU.

### TECHNICAL FIELD

The present invention relates generally to storage area networks and, more particularly, to a method for discovering the topology of logical and storage devices connected through a small computer systems interface (SCSI) interface.

### BACKGROUND OF THE INVENTION

The rapid growth in data intensive applications continues to fuel the demand for raw data storage capacity. As a result, there is an ongoing need to add more storage, file servers, and storage services to an increasing number of users. To meet this growing demand, the concept of storage area network (SAN) was introduced. A SAN is defined as a network having the primary purpose of the transfer of data between computer systems and storage devices. In a SAN environment, storage devices and servers are generally interconnected through various switches and appliances. This structure generally allows for any server on the SAN to communicate with any storage device and vice versa. It also provides alternative paths from a server to a storage device.

To increase the utilizations of SANs, extend the scalability of storage devices, and increase the availability of data, the concept of storage virtualization has recently developed. Storage virtualization offers the ability to isolate a host from the diversity of storage devices. The result is a substantial reduction in support effort and end-user impact.

A SAN enabling storage virtualization operation typically includes one or more virtualization switches. A virtualization switch is connected to a plurality of hosts through a network, such as a local area network (LAN) or a wide area network (WAN). The connections formed between the hosts and the virtualization switches can utilize any protocol including, but not limited to, Gigabit Ethernet carrying packets in accordance with the internet small computer systems interface (iSCSI) protocol, Infiniband protocol, and others. A virtualization switch is further connected to a plurality of storage devices through a interconnect interface, such as Fibre Channel (FC), Parallel SCSI (P.SCSI), and the likes. A storage device is addressable using a logical unit number (LUN). LUNs are used to identify a logical storage device that is presented by a storage subsystem or network device and specified in a SCSI command.

Hosts (i.e., initiators) and storage devices (i.e., targets) connected in a SAN architecture need to find and identify each other to communicate. The process used by the host for identifying exposed targets and establishing their address locations is called discovery. In a SAN where hosts are connected directly to storage devices, e.g., through a SCSI bus, a host can automatically discover storage devices on a SCSI bus, for example, by using a SCSI ‘devices’ command. The SCSI ‘devices’ command initiates a discovery process on the SCSI bus and returns to the host a list of attached storage devices. The list includes the number of attached storage devices, and for each attached device the bus ID and target ID. The SCSI ‘devices’ command may also return, for each attached device, attributes associated with the device such as vendor name, vendor unique identifier, serial number, capacity, and so on.

In a SAN including a virtualization switch, storage devices are not directly attached to the hosts, merely communicating with the hosts through a virtualization switch, an IP network, and a storage communication medium. In such a configuration, a host needs to establish three elements for successful discovery: IP address, TCP port number, and iSCSI target name. The host uses the IP address and the TCP port to establish a TCP connection. The iSCSI target name is then used to establish an iSCSI session with the target.

In addition, virtualization switches automatically discover logical units (LUs) exposed on the storage devices and LU paths of the discovered LUs. The discovery process only uses SCSI target name and LUN for identifying the LUs and does not take into consideration the LU attributes (e.g., serial number). For that reason, an automatic discovery process carried by the virtualization switches may identify two or more LU paths directing to the same LU as two different LUs. This may result in an incorrect and inconsistent representation of the storage network connected to the virtualization switch, and thus to data corruption. For instance, two different LU paths directing to the same LU may be identified as two different LU paths of two different LUs. Consequently, the virtualization switch may report, for example, on two LUs having total capacity double than the actual capacity.

Therefore, it would be advantageous to provide a method for identifying discovered LU paths directing to the same LU. It would be further advantageous if the provided method would automatically update changes in the configuration of the discovered LUs and storage devices.

### SUMMARY OF THE INVENTION

A method and apparatus is described for monitoring and controlling a storage network having established one or more paths to connect with at least one storage device, each storage device including at least one logical unit (LU). The method and apparatus performs a discovery of LUs exposed on each target path. For each discovered LU, LU paths associated with each discovered LU are determined. For each discovered LU, attributes related to the discovered LU are identified and the attributes are compared with already discovered LU attributes. When the attributes of a discovered LU are the same as another LU, the determined LU paths of said discovered LU are associated with the other LU, otherwise the determined LU paths of said discovered LU are associated with said discovered LU.

In another embodiment a method for automatic discovery of logical units (LUs) and storage devices connected to a virtualization switch is described. In this embodiment for each target path, LUs exposed on said target path are discovered. For each discovered LU a list of LU paths associated with said LU is determined and at least attributes related to said discovered LU are identified. Attributes of discovered LUs and their paths are compared and correlated.

### BRIEF DESCRIPTION OF THE DRAWINGS

FIG. 1—is an exemplary diagram of a storage area network (SAN) for the purpose of illustrating the principles of the present invention;

FIG. 2—is a schematic diagram illustrating the relationship between targets, logical units and a virtualization switch's output ports;

FIG. 3—a non-limiting flowchart describing the method for automatic discovering of LUs and storage devices attached to a virtualization switch.

### DETAILED DESCRIPTION OF THE INVENTION

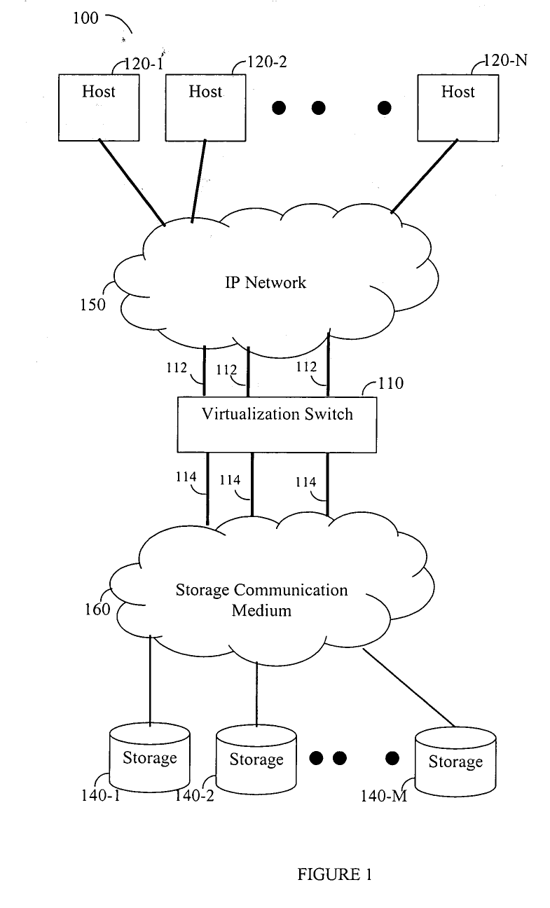

Reference is now made to FIG. 1 where an exemplary diagram of a storage area network (SAN) 100 is shown for the purpose of illustrating the principles of the present invention. SAN 100 comprises of a virtualization switch 110 connected to a plurality of storage devices 140. SAN 100 further includes a plurality of hosts 120 connected to an IP network 150 through, for example, a local area network (LAN) or a wide area network (WAN). Hosts 120 communicate with virtualization switch 110 through IP network 150. The connections formed between hosts 120 and virtualization switch 110 can utilize any protocol including, but not limited to, Gigabit Ethernet carrying packets in accordance with the FC protocol, iSCSI protocol, Infiniband protocol, and others. The connections may be routed to virtualization switch 10 through an Ethernet switch. Storage devices 140 may include, but are not limited to, tape drives, optical drives, disks, and redundant array of independent disks (RAID). Each storage device (also referred to as a “target”) may include one or more LUs as defined by the storage device's vendor or by a system administrator. For example, RA/D stores data on multiple storage devices in a redundant fashion, such that data can be recovered in the event of failure of any one of the storage devices in the redundant array. Each storage device or group of storage devices in the RAID may be configured to operate as an independent LU. Another example is a storage subsystem that packages multiple storage devices in a separate cabinet, along with its own power supply, control software, diagnostics, and so on. Storage devices 140 communicate with virtualization switch 110 through storage communication medium 160. Storage communication medium 160 may be, but is not limited to, a fabric of FC switches, a SCSI bus, and the like.

Virtualization switch 110 operates within SAN 100 and is further connected in the data path between the hosts and the LUs. Virtualization switch 110 includes a plurality of input ports 112 and a plurality of output ports 114. Input ports 112 may be, but are not limited to, gigabit Ethernet ports, FC ports, pSCSI ports, and the others. Output ports 114 may be, but are not limited to, FC ports, iSCSI ports, pSCSI ports, and the others. An input port 112 is capable of carrying packets in accordance with transport protocols including, but not limited to, iSCSI protocol, TCP/IP protocol, Infiniband protocol, or any other transport protocol. An output port 114 is capable of carrying frames in accordance with the transport protocols including, but not limited to, SCSI parallel interface (SPI) protocol, iSCSI protocol, FCP protocol, or any other protocols. Virtualization switch 110 further includes a common layer of storage drivers (not shown) that allows interfacing with output ports 114. The storage drivers conceal the type of the accessed port's type (e.g., SPI, FCP, and iSCSI) to virtualization switch 110. This way virtualization switch 110 may communicate with a target storage device 140 connected to an output port 114 using a common application interface. The operation of virtualization switch 110 is further disclosed in U.S. patent application Ser. No. 10/694,115 entitled “A Virtualization Switch and Method for Performing Virtualization in the Data-Path” assigned to common assignee and which is hereby incorporated for all that it contains.

As discussed above, the connection between virtualization switch 110 and a storage device 140 is formed through one of the output ports 114 and storage communication medium 160. The path established between an output port 114 and an input port of a storage device 140 is defined as a “target path”. For each target there exists a list of associated target paths. A single output port 114 may be connected to one or more targets. For each target path, a LU discovery process for identifying LUs and LU paths is performed. An LU path defines the connection path between an output port 114 and a LU that resides in a designated target via a specific input port of the target. For each LU, there exists a list of associated LU paths. Additionally, for each discovered LU its attributes are retrieved. These attributes may be, but are not limited to, vendor identification, serial number, device identification, capacity, and the LU configurations. The LU configurations determine, for example, type of errors reported by the LU, caching capabilities, firmware version, and the like. The LU attributes allow identifying if a single LU has more than one LU path.

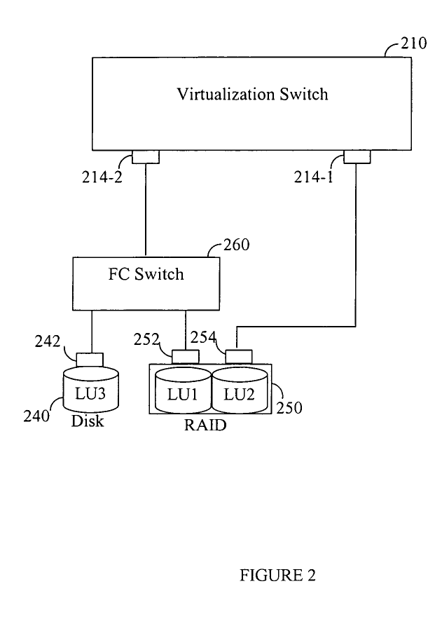

Reference is now made to FIG. 2 where a schematic diagram illustrating the relationship between targets, LUs, and the virtualization switch output ports is shown. FIG. 2 shows virtualization switch 210 having two output ports 214-1 and 214-2, as well as a disk 240, and a RAID 250. Disk 240 has a single port 242 and includes a single LU “LU3” with a LUN ‘3’. RAID 250 has two ports 252 and 254 and includes two LUs “LU1” and “LU2” with LUNs ‘1’ and ‘2’ respectively.

In this example, there is a direct connection between output port 214-1 and RAID 250, while the connection between output port 214-2, disk 240 and RAID 250 is formed through a FC switch 260. Thus, for disk 240 a single target path is discovered while for RAID 250 two target paths are found. A discovered target path is presented using the pair <I, T>, where ‘I’ is the virtualization switch's output port number (e.g., output port 214), and ‘T’ is the target port number. That is, the discovered target paths are:
1) <214-2, 242>
2) <214-1, 254>
3) <214-2, 252>.

Each target path may be further represented using the type connection (e.g. PSCSI, FC, and so on) and a target identifier. For FC connection a target path is uniquely identified by local and remote port names. For each target path, a LU discovery process is performed and a list of LU paths is generated. Each LU path is defined as a combination of target path and LUN. That is, a discovered LU path may be presented using the notation <I, T, LUN>. In this example, five different LU paths can be discovered:
1) <214-2, 242, ‘3’>
2) <214-2, 252, ‘1’>
3) <214-2, 252, ‘2’>
4) <214-1, 254, ‘1’>
5) <214-1, 254, ‘2’>

The present invention identifies and distinguishes between multiple LU paths connected to the same LU using the attributes of the LU and not by the LUN. That is to say that different LUNs may not indicate, necessarily, different LUs.

In an embodiment of this invention, virtualization switch 210 may perform load-balancing and failover between LU paths. The load-balancing algorithm may be, but is not limited to, random, round-robin, weighted round robin, or any other priority based load balancing algorithm. The load balancing and failover functions are executed and controlled by a proprietary data object called “LU strategy”. The LU strategy object maintains a list of active LU paths and a list of inactive LU paths. For example, inactive and active LU paths may be associated with a RAID having two controllers, each with its own port. In such a RAID, a first controller is flagged as active and a second controller is flagged as inactive and failover strategy is defined between these controllers. The inactive paths are used in the case of failover, where alternate active paths are used for load balancing purposes. Once an active LU path is overloaded or the connection on this path is broken, the LU strategy object switches to a different active LU path. For instance, if LU path <214-2, 252, ‘2’> is overloaded the LU strategy object may switch to LU path <214-1, 254, ‘2’>.

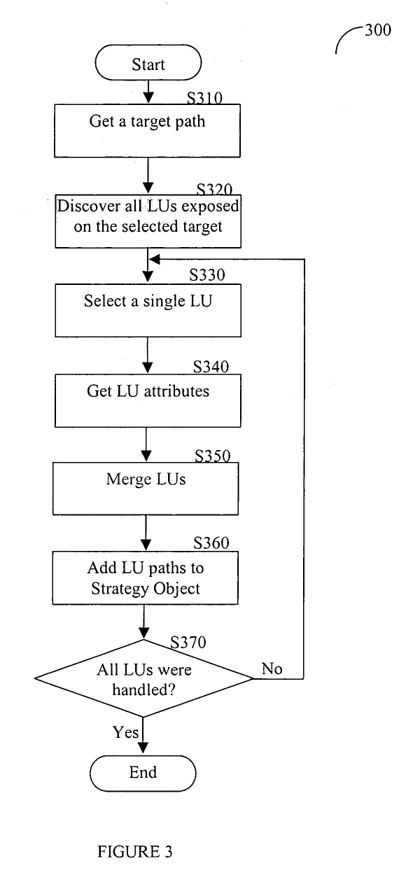

Reference is now made to FIG. 3 where a non-limiting flowchart 300 describing the method for automatic discovery of logical and physical storage devices attached to a virtualization switch and for identifying LU paths with the same LU, is shown. The method described herein is executed, each time a new target path is discovered and reported to the virtualization switch by a transport layer. At step S310, a new target path to be handled is reported by a driver controlling one of the output ports 114. A target path is defined by the port identifier of output port 114 and an input port identifier of the target (i.e., that pair <I, T>). The detected target path is saved in a target path list, which includes all target paths detected by the output ports 114. At step S320, all LUs exposed on the new reported target path are discovered. For each LU, a LU identifier is allocated. The LU identifier may be a combination of a LUN and the target's name in which the LU resides. Alternatively, the LU identifier can be set to an identification descriptor value as described in the device identification page. The device identification page provides the means to retrieve one or more identification descriptors applying to a LU. A LU may have more than one identification descriptor. Subsequently, for each target path a list of LU paths is generated. A LU path is defined by the port identifier of an output port 114, target's input port identifier, and LUN i.e., <I, T, LUN>. Each LU maintains a list of its paths. At step S330 a single LU from the LUs that were discovered at step S320 is chosen. At step S340, the attributes of the selected LU are retrieved through the selected LU path. The LU's attributes include, but are not limited to, a LU identifier, vendor identification, a serial number, device identification, capacity, and LU's configurations. At step S350, the method tries to merge LUs having the same attributes. Specifically, the method searches for an already discovered LU having the same attributes as the selected LU. If such a LU is found, then the LU paths of the selected LU are later added to the LU path list of the already discovered LU. If such a LU is not found, then the selected LU is defined as a new discovered LU. The exposed LUs are saved in a global list maintained by the virtualization switch. Each new discovered LU is added to the list of the discovered LUs. This list does not include two or more identical LUs, i.e., LUs having the same attributes. At step 360, the new discovered LU path is added to the LU strategy object. Additionally, for each new LU path it is determined whether the path is active or inactive. At step S370, a check is made to determine if there are more LUs to be handled, and if there are the execution continues with step S330; otherwise, the execution is ended.

In another embodiment of this invention the method described herein handles notifications of changes in the storage devices topology. That is, if a new storage device or a LU is added or removed, the method detects the changes and updates the target path list, the LU path list, and the list of the exposed LUs accordingly. Furthermore, the method handles any notifications of any changes in the configuration of the storage device or LU. To facilitate this, the method provided monitors the execution of the SCSI commands. If a SCSI command fails to complete its execution, a check is performed to determine if the cause is a change in the storage device configuration. If so, the changes are retrieved from the storage device and updated in the virtualization switch. The changes in the storage devices topology and configuration are further reported to the user.

In another embodiment of the disclosed invention a graphical user interface (GUI) is used to display the physical SAN topology and the topology information of the plurality of storage devices and their LUs. Topological data for each LU includes, but is not limited to, a LUN, a number of LU paths, capacity, and other attributes associated with the LU. The storage devices topology shows the actual connection between an output port 114 to the target storage device 140 through the storage communication medium 160. Furthermore, the various targets and LU paths discovered during the discovery process are presented. The displayed topology is automatically updated if a LU or a storage device is added or removed.

1. A method for automatic discovery of logical units (LUs) and storage devices connected to a virtualization switch, said LUs being discovered with their associated LU paths, said method comprising the steps of:
for each target path, discovering LUs exposed on said target path;
iteratively, for each discovered LU generating a list of LU paths associated with said LU;
retrieving at least attributes related to said discovered LU; and,
correlating between identical LUs, wherein said LU paths directing to said identical LUs are identified.

2. The method of claim 1, further comprising the step of:
detecting status modification in said LUs and said storage devices.

3. The method of claim 1, further comprising the step of:
displaying by means of at least a graphical user interface (GUT) topological data of said LUs and said storage devices.

4. The method of claim 1, wherein said storage devices include at least one of: a tape drive, tape library, optical drive, disk, redundant array of independent disks (RAID).

5. The method of claim 1, wherein said target path includes a physical connection established between an output port of said virtualization switch and an input port of one of said storage devices.

6. The method of claim 1, wherein said LU path includes a logical path established with said LU exposed on said target path.

7. The method of claim 1, wherein said LU attributes include at least one of: vendor identification, serial number, device identification, capacity.

8. The method of claim 1, wherein said step of correlating between identical LUs further includes the steps of:
searching in a LU list for at least one LU having LU attributes the same as said discovered LU;
if such LU was found, adding the list of LU paths of said discovered LU to a LU found in said LU list; else,
adding to said LU list said discovered LU.

9. The method of claim 8, wherein said LU list includes LUs exposed on said virtualization switch.

10. The method of claim 9, wherein said LU list is dynamically updated.

11. The method of claim 8, wherein said list of LU paths includes LU paths directing to a designated LU.

12. The method of claim 11, wherein said list of LU paths is dynamically updated.

13. The method of claim 12, wherein said method further comprising at least one of:
load balancing between LU paths in said list of LU paths;
failover between LU paths in said list of LU paths.

14. The method of claim 13, wherein said load balancing is performed using at least one of the following algorithms: recently used, round robin, weighted round robin, random, least loaded LU path.

15. The method of claim 1, wherein said virtualization switch is connected to said plurality of storage devices through a storage communication medium.

16. The method of claim 16, wherein said storage communication medium comprises at least one of: fabric of Fibre Channel switches, SCSI bus.

17. A computer-readable medium having stored thereon computer executable code for discovering of logical units (LUs) and storage devices connected to a virtualization switch, said LUs are being discovered with their associated LU paths, said code for performing the steps of:
for each target path, discovering LUs exposed on said target path;
iteratively, for each discovered LU generating a list of LU paths associated with said LU;
retrieving at least attributes related to said discovered LU; and,
correlating between identical LUs, wherein said LU paths directing to said identical LUs LU are identified.

18. The computer executable code of claim 17, further performing the step of:
detecting status modification in said LUs and said storage devices.

19. The computer executable code of claim 17, further performing the step of:
displaying by means of at least a graphical user interface (GUI) topological data of said LUs and said storage devices.

20. The computer executable code of claim 17, wherein said physical storage devices include at least one of: a tape drive, optical drive, disk, sub-disk, redundant array of independent disks (RAID).

21. The computer executable code of claim 17, wherein said target path includes a connection established between an output port of said virtualization switch and an input port of one of said storage devices.

22. The computer executable code of claim 17, wherein said LU path includes a logical path established with said LU exposed on said target path.

23. The computer executable code of claim 17, wherein said LU attributes include at least one of: vendor identification, serial number, device identification, capacity.

24. The computer executable code of claim 17, wherein the following steps comprise said correlating between identical LUs:
searching in a LU list for at least one LU having attributes the same as said discovered LU;
if such LU was found adding said list of LU paths of said discovered LU to the LU found in said LU list; else,
adding to said LU list said discovered LU.

25. The computer executable code of claim 24, wherein said LU list includes LUs exposed on said virtualization switch.

26. The computer executable code of claim 25, wherein said LU list is dynamically updated.

27. The computer executable code of claim 24, wherein said list of LU paths comprises LU paths directing to a designated LU.

28. The computer executable code of claim 27, wherein said list of LU paths is dynamically updated.

29. The computer executable code of claim 28, further performing at least one of:
load balancing between LU paths in said list of LU paths;
failover between LU paths in said list of LU paths.

30. The computer executable code of claim 29, wherein said load balancing is performed using at least one of the following algorithms: recently used, round robin, weighted round robin, random, least loaded LU path.

31. The computer executable code of claim 17, wherein said virtualization switch is connected to said plurality of storage devices through a storage communication medium.

32. The computer executable code of claim 31, wherein said storage communication medium comprises at least one of: fabric of Fibre Channel switches, SCSI bus.

33. A virtualization switch operatively connected with at least one storage device including logical units (LUs) in a storage network, said virtualization switch comprising:
a plurality of input ports to communicate with a plurality of hosts;
a plurality of output ports to communicate with a plurality of storage devices;
a storage interface for interfacing with said plurality of storage devices;
a processor; and,
a memory including at least software instructions adapted to cause said virtualization switch to perform the steps of:
for each target path, discovering LUs exposed on said target path;
iteratively, for each discovered LU determining LU paths associated with said discovered LU;
retrieving at least attributes related to said discovered LU; and,
correlating between identical LUs.

34. The virtualization switch of claim 33, said virtualization switch adapted for operation in at least one of: storage area network (SAN), network-attached storage (NAS).

35. The virtualization switch of claim 33, wherein the connection with said plurality of input ports and plurality of hosts is formed through at least an internet protocol (IP) network.

36. The virtualization switch of claim 33, wherein said IP network is at least one of:
local area network (LAN), wide area network (WAN), geographically distributed network.

37. The virtualization switch of claim 33, wherein the connection to said storage device is formed through a storage communication medium.

38. The virtualization switch of claim 33, wherein said input ports are capable of communicating using at least one of the following protocols: Fibre Cannel (FC), parallel small computer system interface (Parallel SCSI), internet small computer system interface (iSCSI), transmission control protocol (TCP)/internet protocol (IP), Infiniband.

39. The virtualization switch of claim 33, wherein said output ports are capable of communicating using at least one of the following protocols: Fibre Cannel (FC), parallel small computer system interface (SCSI), internet small computer system interface (iSCSI), transmission control protocol (TCP)/internet protocol (IP), Infiniband.

40. The virtualization switch of claim 33, wherein said target path includes a physical connection established between an output port of said virtualization switch and an input port of one of said storage devices.

41. The virtualization switch of claim 33, wherein said LU path comprises a logical path established with said LU exposed on said target path.

42. The virtualization switch of claim 33, wherein said correlating between identical LUs includes:
comparing attributes of said discovered LU with attributes of previously discovered LUs;
when said discovered LU is found to have the same attributes as a previously discovered LU, adding the list of LU paths of said discovered LU to the previously discovered LU; and,
if a previously LU having the same LU attributes as said discovered LU was not found, adding to said LU list said discovered LU.

43. A device in a storage network having established one or more paths to operatively connect with a storage device, said storage device including logical units (LUs), said device comprising:
a discovery circuit portion for discovering LUs exposed on each target path;
a determining circuit portion for, each discovered LU, determining LU paths associated with said discovered LU;
an interfacing circuit portion for retrieving at least attributes related to said discovered LU; and,
a correlation circuit portion for identifying identical LUs.

44. The device of claim 43, wherein a LU path defines a logical connection path between said device and a LU that resides in a storage device.

45. A computer system for monitoring and controlling a storage network having established one or more paths to operatively connect with at least one storage device, each storage device including at least one logical unit (LU), comprising:
means for discovering LUs exposed on each target path;
means for determining LU paths associated with each discovered LU;
means for retrieving at least attributes related to said discovered LU; and,
means for comparing attributes of discovered LUs, wherein when the attributes of a discovered LU are the same as another LU, the determined LU paths of said discovered LU are associated with the other LU, otherwise the determined LU paths of said discovered LU are associated with said discovered LU.

46. A method monitoring and controlling a storage network having established one or more paths to operatively connect a device with at least one storage device, each storage device including at least one logical unit (LU), said one of more paths being a physical connection established between an output port of said device and an input port of one of said storage devices and a LU path being a logical path established with an LU exposed on a target path, said method comprising the steps of:
discovering LUs exposed on each target path;
determining LU paths associated with each discovered LU;
retrieving at least attributes related to said discovered LU; and,
comparing attributes of discovered LUs, wherein when the attributes of a discovered LU are the same as another LU, the determined LU paths of said discovered LU are associated with the other LU, otherwise the determined LU paths of said discovered LU are associated with said discovered LU.
